(19) United States
(12) Patent Application Publication
(10) Pub. No.: US 2010/0092806 A1
(43) Pub. Date: Apr. 15, 2010

(54) MINIATURE POWERED ANTENNA FOR WIRELESS COMMUNICATIONS AND RELATED SYSTEM AND METHOD

(75) Inventors: Andrzej Peczalski, Eden Prairie, MN (US); Steven J. Eickhoff, Brooklyn Park, MN (US)

Correspondence Address: HONEYWELL/MUNCK;Patent Services, 101 Columbia Road, P.O. Box 2245, Morristown, NJ, 07962-2245, US

(73) Assignee: Honeywell International Inc., Morristown, NJ (US)

(21) Appl. No.: 12/350,086

(22) Filed: Jan. 7, 2009

Related U.S. Application Data
(60) Provisional application No. 61/105,314, filed on Oct. 14, 2008.

(51) Int. Cl. H01M 14/00; H01R 43/00

(52) U.S. Cl. 429/8; 429/19; 29/592.1

(57) ABSTRACT

An apparatus includes a power source configured to provide power to one or more external components. The power source includes one or more metallization layers. At least one of the one or more metallization layers is configured as an antenna for transmitting or receiving wireless signals. The power source could include a hydrogen generator configured to produce hydrogen gas and a fuel cell configured to generate an electrical current using the hydrogen gas. The hydrogen generator could include a fuel for producing the hydrogen gas and a selectively permeable membrane surrounding the fuel. The fuel cell could include a first electrode surrounding the selectively permeable membrane, a proton exchange membrane surrounding the first electrode, and a second electrode surrounding the proton exchange membrane. The hydrogen generator may be configured to produce the hydrogen gas using water, and the power source may consume only oxygen gas and optionally water vapor from an ambient environment.

### CROSS-REFERENCE TO RELATED APPLICATIONS

This application claims priority under 35 U.S.C. §119(e) to U.S. Provisional Patent Application No. 61/105,314 filed on Oct. 14, 2008, which is hereby incorporated by reference.

### TECHNICAL FIELD

This disclosure relates generally to wireless systems and more specifically to a miniature powered antenna for wireless communications and related system and method.

### BACKGROUND

Wireless devices often require long-lasting power supplies (such as batteries) and wireless antennas. The batteries often need to be compact or conformal in size, and the antennas often need to be full size (half wavelength) for good gain. However, these types of wireless devices are often cost-sensitive. Conventional batteries often have limited energy densities and are typically standardized in size and shape. Custom batteries, such as flat batteries for mobile telephones or laptop computers, are typically expensive. Also, conventional antennas are usually separate metal wires or metal patterns printed on rigid circuit boards.

### SUMMARY

This disclosure provides a miniature powered antenna for wireless communications and related system and method.

In a first embodiment, an apparatus includes a power source configured to provide power to one or more external components. The power source includes one or more metallization layers. At least one of the one or more metallization layers is configured as an antenna for transmitting or receiving wireless signals.

In particular embodiments, the apparatus has an elongated form factor.

In other particular embodiments, the power source includes a hydrogen generator configured to produce hydrogen gas and a fuel cell configured to generate an electrical current using the hydrogen gas. The hydrogen generator could include a fuel for producing the hydrogen gas and a selectively permeable membrane surrounding the fuel. The fuel cell could include a first electrode surrounding the selectively permeable membrane, a proton exchange membrane surrounding the first electrode, and a second electrode surrounding the proton exchange membrane (where at least one of the electrodes is configured as the antenna). The fuel cell could also include a perforated sheet surrounding the selectively permeable membrane (where the first electrode is formed on the perforated sheet) and a cover surrounding the proton exchange membrane (where the second electrode is formed on the cover).

In yet other particular embodiments, the hydrogen generator is configured to produce the hydrogen gas using water produced by the fuel cell, and the hydrogen generator and the fuel cell are water-neutral and consume only oxygen gas from an ambient environment. In other particular embodiments, the hydrogen generator is configured to produce the hydrogen gas using water from an ambient environment, and the hydrogen generator and the fuel cell consume only oxygen gas and water vapor from the ambient environment.

In still other particular embodiments, the hydrogen generator is configured to produce the hydrogen gas using a reversible metal hydride. Also, the hydrogen generator could be configured to produce pulses of power, and the hydrogen generator may be configured to recharge the reversible metal hydride using a chemical hydride.

In additional particular embodiments, the apparatus further includes an energy storage device configured to be charged by the fuel cell and to provide pulses of power to a load. In other particular embodiments, the apparatus further includes integrated circuitry coupled to the antenna and configured to generate signals to be transmitted wirelessly by the antenna and/or process signals received wirelessly by the antenna.

In a second embodiment, a system includes a power source formed from a plurality of fibers. Each fiber includes a hydrogen generator configured to produce hydrogen gas and a fuel cell configured to generate an electrical current using the hydrogen gas.

In a third embodiment, a method includes forming an elongated power source, where the power source includes one or more metallization layers. The method also includes coupling at least one of the one or more metallization layers to communication circuitry. The communication circuitry is configured to use the at least one metallization layer as an antenna for transmitting or receiving wireless signals.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1A and 1B illustrate an example miniature powered antenna in accordance with this disclosure;

FIG. 2 illustrates an example wireless device with a miniature powered antenna in accordance with this disclosure;

FIGS. 3A and 3B illustrate an example wireless device and an example system with miniature powered antennas in accordance with this disclosure;

FIG. 4 illustrates an example system with miniature power sources in accordance with this disclosure; and

FIG. 5 illustrates an example method for forming a miniature powered antenna in accordance with this disclosure.

### DETAILED DESCRIPTION

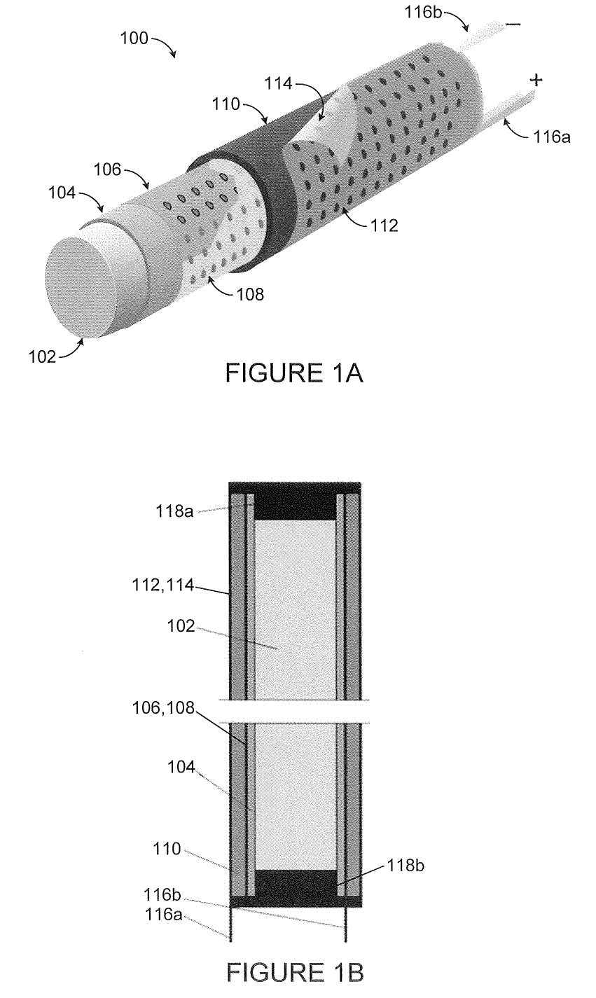

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIGS. 1A and 1B illustrate an example miniature powered antenna 100 in accordance with this disclosure. The embodiment of the miniature powered antenna 100 shown in FIGS. 1A and 1B is for illustration only. Other embodiments of the miniature powered antenna 100 could be used without departing from the scope of this disclosure.

In this example embodiment, the miniature powered antenna 100 includes a thin flexible power source having (i) a proton exchange membrane (PEM) fuel cell and (ii) an unregulated or self-regulated chemical hydrogen generator. The PEM fuel cell represents an elongated structure and may be referred to as a fuel cell fiber. The hydrogen generator is also an elongated structure. In general, the hydrogen generator produces hydrogen gas, which is used by the fuel cell to produce power. The miniature powered antenna 100 in this example is formed by concentric structural layers, which can help to simplify assembly and gas sealing.

The hydrogen generator in this example includes a fuel 102. The fuel 102 represents any suitable material(s) for producing hydrogen, such as lithium aluminum hydride (LiAlH4) or other chemical hydride fuel. The fuel 102 could also have any suitable form(s), such as powder or pellets. In particular embodiments, the fuel 102 could represent one or more reversible metal hydrides that can adsorb/desorb hydrogen reversibly. In these embodiments, the rapid desorbtion of hydrogen can be used to generate pulses of power (which may be much higher than a regular chemical hydride/water reaction is capable of producing on its own). The reversible metal hydride could be “recharged” with hydrogen when a chemical hydride consumes water vapor from the ambient environment. Additional details regarding this type of fuel cell are disclosed in U.S. Patent Publication No. 2008/0268303.

A membrane 104 surrounds the fuel 102. The membrane 104 represents a selectively permeable membrane that allows gas (such as hydrogen gas and water vapor) to pass through the membrane 104. The membrane 104 can also function as a particulate filter to reduce or prevent particulate matter from passing through the membrane 104. The membrane 104 could be formed from any suitable gas permeable material(s). The water permeability of the membrane 104 may be tailored to limit the hydrogen generation rate to a desired value. This may, for example, limit the pressure inside the fuel cell when used in a high humidity environment, which can prevent catastrophic discharge of hydrogen.

The fuel cell in this example includes various concentric structural layers around the hydrogen generator. As shown in FIG. 1, a perforated sheet 106 surrounds the membrane 104. The perforated sheet 106 could be formed from any suitable material(s). Example materials include high-strength ultra-thin polyethylene terapthalate (PET) tubing, plastic, or other flexible and low-hydrogen permeable structural material. An electrode 108 is formed on the perforated sheet 106, such as on the outside of the perforated sheet 106. The electrode 108 could represent an anode of the fuel cell. The electrode 108 could be formed from any suitable material(s), such as metal.

A proton exchange membrane 110 surrounds the electrode 108. The membrane 110 represents a proton permeable membrane that allows protons to pass through the membrane 110 during operation of the fuel cell. The proton exchange membrane 110 could be formed from any suitable material(s) permeable to protons. For example, each side of the proton exchange membrane 110 could include an electrode layer formed from carbon and a platinum catalyst.

A cover 112 and an electrode 114 surround the membrane 110. The cover 112 could be formed from any suitable material(s), such as PET tubing, plastic, or other flexible and low-hydrogen permeable structural material. The cover 112 could “shrink wrap” the fiber and may be perforated for better gas exchange. The electrode 114 is formed on the cover 112, such as on the inside of the cover 112. The electrode 114 could represent a cathode of the fuel cell. The electrode 114 could be formed from any suitable material(s), such as metal.

In this example, two terminals 116a-116b provide electrical connectivity to the fuel cell. Here, the terminal 116a is coupled to the electrode 114, and the terminal 116b is coupled to the electrode 108. The terminals 116a-116b allow external circuitry to receive power from the fuel cell. The terminals 116a-116b could be formed from any suitable material(s), such as metal.

As shown in FIG. 1B, the miniature powered antenna 100 further includes two sealing plugs 118a-118b. The sealing plugs 118a-118b seal the ends of the miniature powered antenna 100. This helps to substantially prevent hydrogen gas and water vapor from escaping the miniature powered antenna 100. The sealing plugs 118a-118b could be formed from any suitable material(s), such as a gas-impermeable material.

The operation of the hydrogen generator and the fuel cell could occur as follows. The fuel 102 reacts with water vapor to produce hydrogen gas. If the fuel 102 includes LiAlH₄, this reaction can be expressed as LiAlH₄+4H₂O→4H₂+Solids. The water vapor could be scavenged directly from the fuel cell's cathode (electrode 114). The hydrogen gas from the hydrogen generator is provided to the fuel cell, which combines the hydrogen gas with oxygen gas from the ambient environment to produce energy. This reaction can be expressed as 4H₂+2O₂→4H₂O+Energy. The overall reaction can therefore be expressed as LiAlH₄+2O₂→Energy+Solids. From this, it can be seen that the overall reaction is water neutral, consumes only oxygen from the ambient environment, and produces no gaseous byproducts. Note that some water from the ambient environment may be required initially to begin the reaction process but that little to no water from the ambient environment may be needed after that point.

In this example, the reaction rate of the fuel cell can be determined by the electrical load placed on the fuel cell. This makes the fuel cell unregulated or self-regulated, which allows passive regulation of the fuel cell in the miniature powered antenna 100. Passive regulation and water scavenging by the hydrogen generator may enable the miniature powered antenna 100 to obtain a high energy density and a high specific energy in a small package.

In accordance with this disclosure, the electrodes 108 and 114 in the fuel cell may double as an antenna in wireless applications. In other words, the electrodes 108 and 114 in the fuel cell can also function as an antenna to transmit and/or receive wireless signals. The electrodes 108 and 114 can be configured to form any suitable type of antenna. For example, the electrodes 108 and 114 could be configured to form a dipole antenna (which could be useful in convert applications) or a planar antenna such as a patch or dish antenna (which could be useful for extended long-range radio frequency or “RF” communications).

As noted above, the hydrogen generator in the miniature powered antenna 100 has an unregulated or self-regulated design, which can enable a dramatic reduction in size and provide great flexibility in the form factor of the antenna 100. Also, multiple miniature powered antennas 100 may be connected in series or parallel to provide a desired amount of operating power, enabling their use in a wide range of miniature and other electronic devices.

In these embodiments, the permeability of the proton exchange membrane 110, the membrane 104, and the PET-based electrodes (layers 106-108 and 112-114) to protons and water can vary based on factors such as external humidity, temperature, and internal pressure. The permeability may, among other things, determine the balance between current leakage and internal pressure for an unregulated fuel cell. In light of this, a characterization of the permeability of the antenna 100 can be determined against humidity, temperature, and internal pressure. This may allow the development of an unregulated fuel cell model that scales with size and geometry (such as planar versus cylindrical). The model can include permeability, diffusion, reaction rates, activation polarization, and ohmic losses versus temperature, internal pressure and external humidity. This model may be used to design antennas 100 for specific uses or environments.

In particular embodiments, the membrane 110, the membrane 104, and the electrodes (layers 106-108 and 112-114) could be formed in tubes of having a diameter of less than 1 mm. The miniature powered antenna 100 can be fabricated in any suitable manner. For example, any technique providing good control of fuel cell parameters could be used, such as dip forming, shrink-wrapping, or other suitable process(es). As a particular example, the antenna/electrodes could be printed on the fuel cell structure.

As another particular example, as noted above, the electrodes (layers 106-108 and 112-114) could be formed using metallized PET, and shrink-wrapping fiber-sized PET tubes has been performed previously for medical and other equipment. High volume fabrication using shrink-wrapping could involve the use of specialized equipment, and parameters in the fabrication can include permeability and selectivity of the films used in the shrink-wrapping. The fabrication process could also be scalable to large volume and include metrics such as fuel cell size and performance (like specific energy or energy density). Note that any suitable metallization layer(s) can be placed on any suitable substrate(s) to form the electrodes. Example substrates may include PET, KAPTON, or other inexpensive and flexible material(s) having a low permeability to hydrogen. Also note that the metal or other conductive material placed on the substrate could be gold or other corrosion resistant metal or other material(s).

In addition, woven fuel cell mats can be formed using the antennas 100. Parameters can include fuel cell size and performance (like specific energy or energy density).

In this way, the miniature powered antenna 100 integrates a miniature antenna with a power supply into a single structure. Moreover, the antenna 100 can be used in a wide variety of applications, from covert applications to long-range RF communications. The miniature powered antenna 100 could have any suitable size, shape, and energy characteristics. For example, a single miniature powered antenna 100 could have dimensions of 50 mm×0.5mm×1 mm, an energy capacity of 60 mWhr, and a maximum power capacity of 60 mW. Multiple miniature powered antennas 100 could be formed into a 1-10 GHz patch or dish antenna having dimensions of 6 mm×6 mm and an energy capacity of 2.6-260 Whr.

Although FIGS. 1A and 1B illustrate an example miniature powered antenna 100, various changes may be made to FIGS. 1A and 1B. For example, the relative sizes and thicknesses of the various components in FIGS. 1A and 1B are for illustration only. Also, perforations may not be required in certain layers if, for instance, their permeability allows for adequate gas exchange. Further, the fuel cell here could be coupled to an energy storage device (such as a capacitor or a rechargeable battery) that is charged by the fuel cell. This may allow the energy storage device to provide pulses of power to a load. In addition, the miniature powered antenna 100 could include any other suitable power supply and is not limited to using a fuel cell. For instance, the antenna 100 could include a fiber-type rechargeable battery manufactured by ITN ENERGY SYSTEMS. In these embodiments, one or more metallization layers in the fiber-type battery could be used as an antenna. In short, any suitable power supply having one or more metallization layers could be used in the antenna 100.

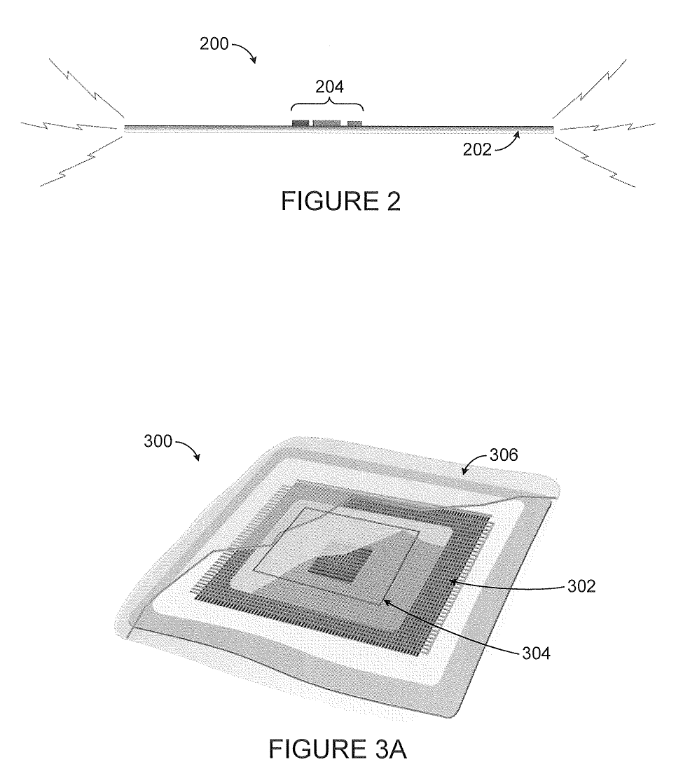

FIG. 2 illustrates an example wireless device 200 with a miniature powered antenna in accordance with this disclosure. The embodiment of the wireless device 200 shown in FIG. 2 is for illustration only. Other embodiments of the wireless device 200 could be used without departing from the scope of this disclosure.

As shown in FIG. 2, the wireless device 200 includes a miniature powered antenna 202 and integrated circuitry 204 placed on the antenna 202. The miniature powered antenna 202 could, for example, represent the antenna 100 shown in FIGS. 1A and 1B.

The integrated circuitry 204 includes components for facilitating wireless communications to and/or from the wireless device 200 via the antenna 202. For example, the integrated circuitry 204 could include an analog front-end and baseband processing circuitry. For incoming signals, the analog front-end could include filters, low-noise amplifiers, down-conversion components such as mixers, and analog-to-digital converters for converting the incoming signals into baseband signals. For outgoing signals, the analog front-end could include digital-to-analog converters, filters, and power amplifiers for converting baseband signals into the outgoing signals. The baseband processing circuitry could process the baseband signals and perform various other functions. As another example, the integrated circuitry 204 could implement a software-defined radio or similar structure, where the analog front-end is relatively simple and the baseband processor performs many of the operations needed for communication. Any other or additional components could be used to facilitate incoming and/or outgoing wireless communications by the wireless device 200.

The integrated circuitry 204 could include circuitry for performing other functions as well. For example, the integrated circuitry 204 could include sensing circuitry configured to detect various conditions, such as movement, speech or other audible sounds, or environmental conditions.

The integrated circuitry 204 could be implemented in any suitable manner. For example, the integrated circuitry 204 could be implemented using a generic, low-cost application-specific integrated circuit (ASIC). The integrated circuitry 204 could also include various components of a simple analog front-end (such as input/output amplifiers and filters used in a software-defined radio) implemented using low cost complimentary metal oxide semiconductor (CMOS) technology.

In a particular implementation of this type of wireless device 200, the antenna 202 is implemented as shown in FIGS. 1A and 1B with a fuel cell power supply. The antenna 202 here could be 0.4-1 mm in diameter and 5 cm long. In this particular implementation, the fuel cell in the antenna 202 could have an energy capacity of 6-72 mWhr with a power output of 1-10 mW or more. Note that application-specific requirements of the wireless device 200 can be addressed in various ways, such as through appropriate design parameters associated with the antenna 202, the power supply in the antenna 202, and amplifiers in the integrated circuitry 204.

Although FIG. 2 illustrates an example wireless device 200 with a miniature powered antenna, various changes may be made to FIG. 2. For example, any suitable integrated circuitry could be used with the antenna 202. Also, multiple antennas 202 could be used in the wireless device 200.

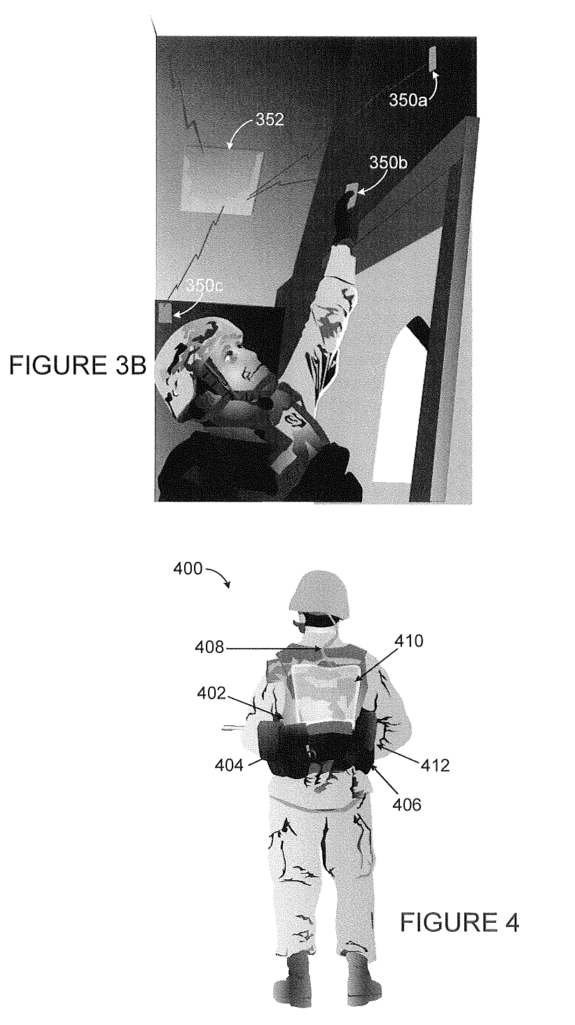

FIGS. 3A and 3B illustrate an example wireless device 300 and an example system 350 with miniature powered antennas in accordance with this disclosure. The embodiments of the wireless device 300 and the system 350 shown in FIGS. 3A and 3B are for illustration only. Other embodiments of the wireless device 300 and the system 350 could be used without departing from the scope of this disclosure.

As shown in FIG. 3A, a wireless device 300 includes a powered antenna 302, integrated circuitry 304, and a casing 306. The powered antenna 302 could, for example, represent a patch or dish antenna formed from multiple miniature powered antennas 100 shown in FIGS. 1A and 1B. As shown here, the powered antenna 302 can essentially serve as a flexible circuit board on which the integrated circuitry 304 is mounted. The integrated circuitry 304 could perform any suitable function(s) depending on the application. The integrated circuitry 304 could be the same as or similar to the integrated circuitry 204 shown in FIG. 2. The casing 306 encases the wireless device 300 and may provide environmental protection for the wireless device 300.

In a particular implementation of this type of wireless device 300, the antenna 302 is implemented using miniature powered antennas 100 as shown in FIGS. 1A and 1B with fuel cell power supplies. The antenna 302 could communicate using a frequency between 1 GHz-10 GHz, be 15 cm×15 cm×1.25 cm in size, have an energy capacity of 9.4-28.1 Whr, and have a peak available power of 22.5-2,250 mW.

A specific use of this type of wireless device is shown in FIG. 3B. In this example, various wireless devices 350a-350c are applied by a soldier within a room of a home, building, or other structure. The wireless devices 350a-350c could represent sensors configured to perform any suitable sensing operations, such as by detecting the presence of certain chemicals or other materials, sensing motion, or capturing audible sounds. The wireless devices 350a-350c are in communication with a larger wireless device 352, which could represent the same type of wireless device but with a larger antenna (and therefore a larger power supply and longer range). The wireless device 352 could, for example, collect data from the other wireless devices 350a-350c and transmit that data over a larger distance.

Although FIGS. 3A and 3B illustrate an example wireless device 300 and an example system 350, various changes may be made to FIGS. 3A and 3B. For example, any suitable integrated circuitry could be used with the antenna 302. Also, the system 350 could include any suitable number and type(s) of wireless devices.

FIG. 4 illustrates an example system 400 with miniature power sources in accordance with this disclosure. The embodiment of the system 400 shown in FIG. 4 is for illustration only. Other embodiments of the system 400 could be used without departing from the scope of this disclosure.

As shown in FIG. 4, the system 400 represents a portable communication system with a body-conformal power source. In this example, the system 400 includes a communications module/radio 402 and a navigation system 404. The communications module/radio 402 represents any suitable wireless communication device, such as an RF radio. The navigation system 404 represents any suitable location or navigation system, such as a GPS system. The system 400 also includes a computer hub subsystem 406, which could implement any suitable type(s) of computing function(s). The system 400 further includes one or more personal network cables 408, which can be used to couple other devices to the communications module/radio 402, the navigation system 404, the computer hub subsystem 406, or other components of the system.

In addition, the system 400 includes a power supply 410 and a snap power plug 412. In this example, the power supply 410 provides operating power to the system 400. The power supply 410 could be formed, for example, from multiple ones of the structure shown in FIGS. 1A and 1B. It may be noted that the structure from FIGS. 1A and 1B could include the hydrogen generator and the fuel cell (or other power source) without also operating as antenna. Optionally, however, the power supply 410 could be used as an antenna for other components of the system 400. For instance, the power supply 410 could represent a patch or dish that transmits and/or receives wireless signals. The snap power plug 412 represents a connection to the power supply 410 and is used to supply power to other components of the system 400.

Some types of fuel cells, such as those fueled by a LiAlH₄-based hydrogen generator, are flexible and can conform to three-dimensional surfaces if required. In this embodiment, the power supply 410 may represent a layered fuel cell fiber fabric. In particular embodiments, the layered fuel cell fiber fabric could be a wearable patch that is 12 inches by 24 inches by 0.5 inches in size. This type of power supply 410 could offer an energy capacity of 79-236 Whr, a specific energy of 1,000-1,500 Whrs/kg, and an energy density of 1,000-1,500 Whrs/cc for 0.4-1 mm diameter fibers (with 10-20 layers of woven fibers). The fuel 102 in the fibers forming the power supply 410 could be treated with a material to prevent the fibers from generating power until desired. For example, a hydrophobic material could be used so that the power supply 410 becomes operational after insertion into water.

Although FIG. 4 illustrates an example system 400 with miniature power sources, various changes may be made to FIG. 4. For example, the power supply 410 could be used in any other suitable type of system.

In any of the devices and systems described above, integrating an antenna, a power supply, and integrated circuitry (such as an analog front-end) may increases wireless communication range, as well as reduce the weight, size, and cost of the device or system. For example, a powered antenna integrated with a fuel cell could have a 115 dB RF link budget at 1 GHz and operate for at least a year or more. As another example, a wireless device or system could have an RF link range of 100-1,300 m over at least a one-year period, and the size of an RF front-end could be less than 1 mm×1 mm in die area. Also, as noted above, fuel cell fibers (or other fibers) may include fiber-like antennas (such as dipole or loop antennas) or be assembled into mats that form planar antennas (such as patch or dish antennas). As can be seen, the fuel cell fibers or other fibers are highly modular, meaning any suitable shape and size can be assembled from the fibers.

Further, the range of a device or system described above could depend on its operational environment. For example, the wireless device 300 could achieve a range of 13,400 m with line-of-sight transmissions, 561 m in a cluttered environment, and 115 m in an extremely cluttered environment. Beyond that, the ends of the fuel cell fibers or other fibers may be stripped (like coaxial wire) to expose contacts of the fuel cell or other power supply for interconnection with larger structures. The fibers may also be made in large quantities, which can help to drive down the cost of the fibers.

In addition, the devices and systems described above may or may not operate continuously. For example, if a wireless device could operate continuously for one year, the wireless device could possibly operate up to ten years with a 10% operational duty cycle. As a particular example, the wireless device 200 could operate as a two-way radio for 100 days by transmitting four times a day at 25 mW for 1 msec. The wireless device 200 could also operate as a transmitter for six hours by transmitting at 100 mW over a 10 msec interval every minute. The wireless device 200 could further operate as a fuel cell-powered wake-up receiver for 100 days by creating up to thirteen pulses of 200 mA with 1 msec duration (with a 47 μF capacitor integrated on the fiber) or by creating up to eight pulses of 1.5 A with one second duration (with a 380 mF supercapacitor, such as one with a size 6 mm×30 mm×48 mm, that is not integrated with the fiber). A fuel cell fiber integrated with an antenna and an RF transceiver could be used in any suitable manner, such as to operate as a beacon, sensor, or tracking device.

The use of fuel cells as a power supply may provide certain benefits depending on the implementation. For example, even the best batteries (such as lithium ion batteries) may have a characteristic specific energy twelve times smaller and an energy density four times smaller than fuel cells (such as lithium hydrate-based cells). Also, the integration of a fuel cell or other power source with an antenna can provide certain benefits. For instance, conventional antennas are often formed from metal printed on circuit boards or plastic packaging (such as wireless cards) or are made of wire or wire mesh. Conventional batteries are separate structures that sometimes conform to the shape of the antennas (such as a paper battery integrated in an RF identification card). Combining the two structures can save space in the wireless device.

Note that the miniature powered antenna 100 disclosed above could be used in any other suitable manner. For example, the miniature powered antenna 100 could be used in wireless industrial devices, such as wireless sensors or wireless actuators. Examples of these types of wireless industrial devices are provided in U.S. patent application Ser. Nos. 11/444,043, 11/796,967, and 12/183,690, which are hereby incorporated by reference. However, the miniature powered antenna 100 could be used in any other suitable device or system. Also, as noted above, the structure shown in FIGS. 1A and 1B could be used in ways that do not require an integrated antenna, such as in the power supply 410 in FIG. 4. In other words, the structure shown in FIGS. 1A and 1B could be used in a wide variety of ways, which may or may not involve wireless antennas.

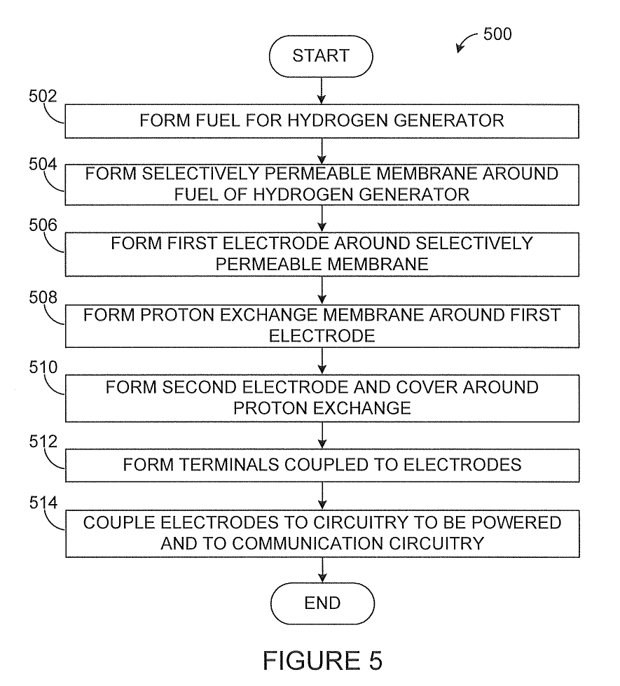

FIG. 5 illustrates an example method 500 for forming a miniature powered antenna in accordance with this disclosure. The embodiment of the method 500 shown in FIG. 5 is for illustration only. Other embodiments of the method 500 could be used without departing from the scope of this disclosure.

Fuel for a hydrogen generator is formed at step 502. This could include, for example, forming a cylindrical structure from LiAlH₄ powder or pellets or other fuel 102. A selectively permeable membrane is formed around the fuel at step 504. This could include, for example, shrink-wrapping the fuel 102 in the selectively permeable membrane 104 or dipping the fuel 102 into a suitable material. This forms a hydrogen generator with a selectively permeable membrane that can also act as a particulate filter.

A first electrode is formed around the selectively permeable membrane at step 506. This could include, for example, forming a perforated sheet 106 around the selectively permeable membrane 104. This could be done by shrink-wrapping. This could also include depositing a metal or other conductive material(s) on the perforated sheet 106 to form the electrode 108. This could occur by dip forming the electrode 108. Note that the electrode 108 could be formed on the perforated sheet 106 before or after the perforated sheet 106 is formed around the selectively permeable membrane 104.

A proton exchange membrane is formed around the first electrode at step 508. This could include, for example, forming a proton exchange membrane 110 around the perforated sheet 106. This could be done by shrink-wrapping.

A second electrode and a cover are formed around the proton exchange membrane at step 510. This could include, for example, forming the electrode 114 on the cover 112 and then wrapping the cover 112 around the proton exchange membrane 110. This could be done by shrink-wrapping. Note that the electrode 114 could also be formed on the proton exchange membrane 110 before the cover 112 is formed around the proton exchange membrane 110.

Terminals coupled to the electrodes are formed at step 512. This could include, for example, forming a terminal coupled to the electrode 108 and another terminal coupled to the electrode 114. The terminals could be formed in any suitable manner.

The electrodes are coupled to circuitry to be powered at step 514. This could include, for example, coupling the terminals 108 and 114 to an external circuit. This step also includes coupling the electrodes to communication circuitry so that the electrodes 108 and 114 can be used as an antenna. This may allow, for example, the electrodes 108 and 114 to be used to transmit and/or receive wireless signals. In this way, a miniature antenna structure can be formed that includes both a power source (a fuel cell and a hydrogen generator in this example) and an antenna. However, as noted above, the structure formed here need not function as an antenna, so coupling the electrodes to communication circuitry may be optional.

Although FIG. 5 illustrates an example method 500 for forming a miniature powered antenna, various changes may be made to FIG. 5. For example, while shown as including a fuel cell, the miniature powered antenna could include any suitable power supply. Also, while shown as a series of steps, various steps in FIG. 5 could overlap or occur in parallel.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a power source configured to provide power to one or more external components, the power source comprising one or more metallization layers;
wherein at least one of the one or more metallization layers is configured as an antenna for transmitting or receiving wireless signals.

2. The apparatus of claim 1, wherein the apparatus has an elongated form factor.

3. The apparatus of claim 1, wherein the power source comprises:
a hydrogen generator configured to produce hydrogen gas; and
a fuel cell configured to generate an electrical current using the hydrogen gas.

4. The apparatus of claim 3, wherein the hydrogen generator comprises:
a fuel for producing the hydrogen gas; and
a selectively permeable membrane surrounding the fuel.

5. The apparatus of claim 4, wherein the fuel cell comprises:
a first electrode surrounding the selectively permeable membrane;
a proton exchange membrane surrounding the first electrode; and
a second electrode surrounding the proton exchange membrane;
wherein at least one of the electrodes is configured as the antenna.

6. The apparatus of claim 5, wherein the fuel cell further comprises:
a perforated sheet surrounding the selectively permeable membrane, the first electrode formed on the perforated sheet; and
a cover surrounding the proton exchange membrane, the second electrode formed on the cover.

7. The apparatus of claim 3, wherein the hydrogen generator is configured to produce the hydrogen gas using water produced by the fuel cell; and
wherein the hydrogen generator and the fuel cell are water-neutral and consume only oxygen gas from an ambient environment.

8. The apparatus of claim 3, wherein the hydrogen generator is configured to produce the hydrogen gas using water from an ambient environment; and
wherein the hydrogen generator and the fuel cell consume only oxygen gas and water vapor from the ambient environment.

9. The apparatus of claim 3, wherein the hydrogen generator is configured to produce the hydrogen gas using a reversible metal hydride.

10. The apparatus of claim 9, wherein the hydrogen generator is configured to produce pulses of power; and
the hydrogen generator is configured to recharge the reversible metal hydride using a chemical hydride.

11. The apparatus of claim 1, further comprising:
an energy storage device configured to be charged by the fuel cell and to provide pulses of power to a load.

12. The apparatus of claim 1, further comprising:
integrated circuitry coupled to the antenna and configured to at least one of: generate signals to be transmitted wirelessly by the antenna and process signals received wirelessly by the antenna.

13. A system comprising:
a power source formed from a plurality of fibers, each fiber comprising:
a hydrogen generator configured to produce hydrogen gas; and
a fuel cell configured to generate an electrical current using the hydrogen gas.

14. The system of claim 13, wherein the fuel cell comprises one or more metallization layers; and
wherein at least one of the one or more metallization layers is configured as an antenna for transmitting or receiving wireless signals.

15. The system of claim 13, further comprising at least one of a wireless radio, a navigation system, and a computer system configured to transmit and receive the wireless signals.

16. The system of claim 13, wherein the hydrogen generator comprises:
a fuel for producing the hydrogen gas; and
a selectively permeable membrane surrounding the fuel.

17. The system of claim 16, wherein the fuel cell comprises:
a first electrode surrounding the selectively permeable membrane;
a proton exchange membrane surrounding the first electrode; and
a second electrode surrounding the proton exchange membrane.

18. The system of claim 13, wherein the hydrogen generator is configured to produce the hydrogen gas using water; and
wherein the hydrogen generator and the fuel cell consume only oxygen gas and optionally water vapor from an ambient environment.

19. The system of claim 13, wherein the hydrogen generator is configured to produce the hydrogen gas using a reversible metal hydride.

20. A method comprising:
forming an elongated power source, the power source comprising one or more metallization layers; and
coupling at least one of the one or more metallization layers to communication circuitry, the communication circuitry configured to use the at least one metallization layer as an antenna for transmitting or receiving wireless signals.
